(19) United States
(12) Patent Application Publication
(10) Pub. No.: US 2024/0003375 A1
(43) Pub. Date: Jan. 4, 2024

(54) FASTENING DEVICE AND METHODS INCORPORATING THE SAME

(71) Applicant: EMATRIX ENERGY SYSTEMS, INC., Southfield, MI (US)

(72) Inventors: Idan KOVENT, Huntington Woods, MI (US); Matt GRIFFITH, Orion Township, MI (US)

(21) Appl. No.: 18/345,206

(22) Filed: Jun. 30, 2023

Related U.S. Application Data
(60) Provisional application No. 63/357,100, filed on Jun. 30, 2022.

(51) Int. Cl. F16B 29/00

(52) U.S. Cl. CPC F16B 29/00

(57) ABSTRACT

A fastening device including a rod threaded on both ends is provided. The rod is crimped at a predefined distance from a first end, with the crimp width being limited to the diameter of the hole(s) the rod will be passed through. The first end may (or may not) be covered with thread locking material. A nut with is installable on the second end, and the second end can be crimped to a predefined distance. In use, the first end is passed through different elements to be joined and threaded into a female thread in the last element of a joint. A driving tool may be used to tighten the rod into the threaded element. The crimp on the first end can prevent the rod from spinning past the crimped portion.

### CROSS-REFERENCE TO RELATED APPLICATIONS

This application claims priority to U.S. Provisional Application No. 63/357,100, filed on Jun. 30, 2022, the entire contents of which being fully incorporated herein by reference.

### FIELD OF THE INVENTION

The present invention is directed to fastening devices useful in assembling machinery and related technology.

### BACKGROUND OF THE INVENTION

Threaded rods are useful in large assemblies where it is impractical or impossible to use shorter fasteners (e.g., a screw, a bolt, etc.). When using a threaded rod (or another fastener), a user often has access to either end of the rod and can tighten a nut (or similar hardware) to achieve a desired tightness. Where a user only has access to one end (i.e., a “free end”), the threaded rod may be threaded into a mating, tapped hole (or similar mating feature) and tightened on the one end with a nut (or similar hardware). This common technique is undesirable in certain applications, as there is no mechanism to prevent the rod from turning substantially in the tapped hole. Thus, the actual force (e.g., axial tensile force, torque value, etc.) through the threaded rod cannot be accurately or precisely determined. A known technique in the art is to weld (or otherwise fully constrain) the rod. This partial solution poses other assembly related problems (e.g., for instance when the rod needs to be assembled later when it becomes impractical or impossible to weld the rod).

Thus, it would be desirable to provide a fastening device to address assembly problems and related problems in the art.

### SUMMARY OF THE INVENTION

One aspect of the invention provides a fastening device, including an elongated member, the elongated member including a first end defining a first threaded portion and a first crimped portion, and a second end defining a second threaded portion. The fastening device also includes a fastener, the fastener disposed on the second end.

Another aspect of the invention provides a method of providing a fastening device. The method includes the steps of: (a) providing a threaded rod, the threaded rod including a first end and a second end; (b) providing a fastener disposed on the second end; (c) crimping a first portion of the threaded rod at a predetermined distance; and (d) crimping a second portion of the threaded rod at a distal position from the first end.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 illustrates a side view of a fastening device in accordance with an exemplary embodiment of the invention.

FIG. 2 illustrates a partial cross-sectional top view of an assembly useful for explaining various exemplary embodiments of the invention.

FIGS. 3A-3C illustrate various perspective views of a fastening device, and portions thereof, in accordance with an exemplary embodiment of the invention.

FIGS. 4A-4D illustrate various block diagram side views of a fastening device, in accordance with another exemplary embodiment of the invention.

FIG. 5 is an exemplary crimping tool useful for explaining various exemplary embodiments of the invention.

FIGS. 6A-6B illustrate what has been referred to herein as a slotted bit, which is essentially a means to engage or clamp onto the crimped end to turn it.

FIG. 7 is a flow diagram of a method of providing a fastening device in accordance with an exemplary embodiment of the invention.

### DEFINITIONS

The instant invention is most clearly understood with reference to the following definitions.

As used herein, the singular form “a,” “an,” and “the” include plural references unless the context clearly dictates otherwise.

As used in the specification and claims, the terms “comprises,” “comprising,” “containing,” “having,” and the like can have the meaning ascribed to them in U.S. patent law and can mean “includes,” “including,” and the like.

As used herein, the term “lateral” refers to a component that is located relatively away from the midline of a subject's body.

As used herein, the term “medial” refers to a component that is located between the proximal distal ends of a device.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

Unless specifically stated or obvious from context, the term “or,” as used herein, is understood to be inclusive.

### DETAILED DESCRIPTION OF THE INVENTION

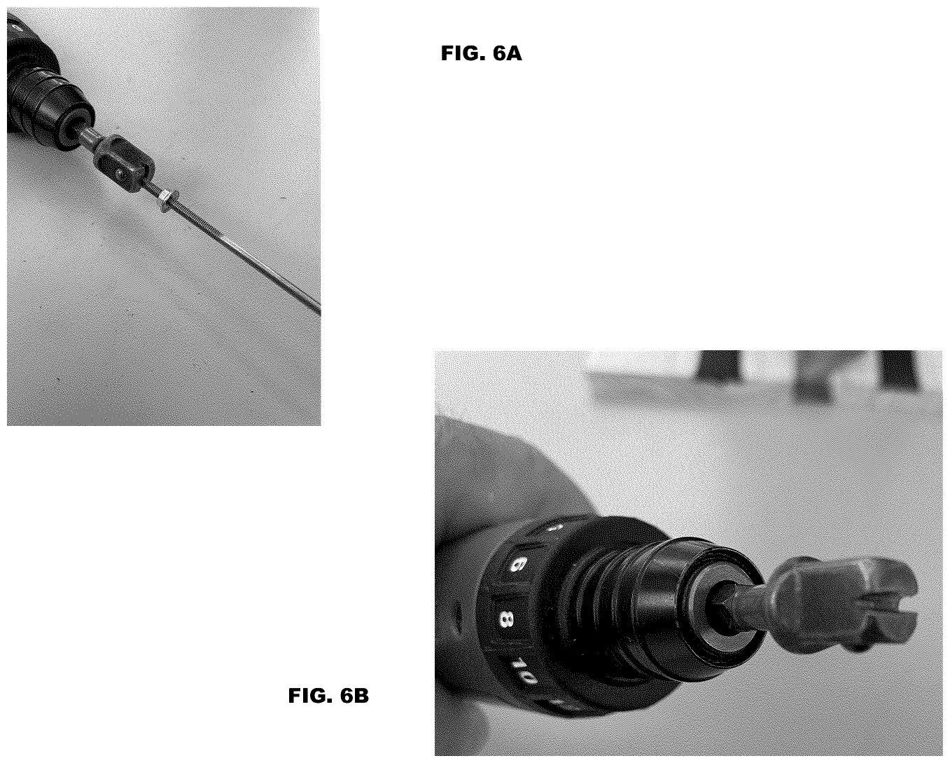

The present invention relates to a fastening device (sometimes referred to as a fastening assembly). Aspects of the present invention relate to a rod threaded on both ends. In one embodiment of the present invention, the rod is crimped at a predefined distance from a first end. The crimp width may be limited to the diameter of the hole(s) the rod will be passed through. In certain embodiments, the first end may (or may not) be covered with thread locking material. In certain embodiments, a nut with (or without) a washer is installed on the second end. In certain embodiments, the second end is crimped to a predefined distance. When using such an embodiment, the first end is passed through different elements to be joined and, for example, threaded into a female thread in the last element of a joint. In certain embodiments, a driving tool (e.g., an inverted flat screwdriver or a slotted bit such as that shown in FIG. 6) may be used to tighten the rod into the threaded element. The crimp on the first end may prevent the rod from spinning past the crimped portion. In certain applications, a socket wrench can be used to drive down a nut attached to the rod and tighten it to the proper torque value.

Throughout the various drawings provided herein, the same reference characters refer to the same element (and similar reference characters, such as those beginning with a “4” instead of a “1” but otherwise the same, e.g., threaded portion 110 and 410, refer to substantially similar elements). Thus, a description of certain elements may be omitted (or limited) in connection with some of the drawings.

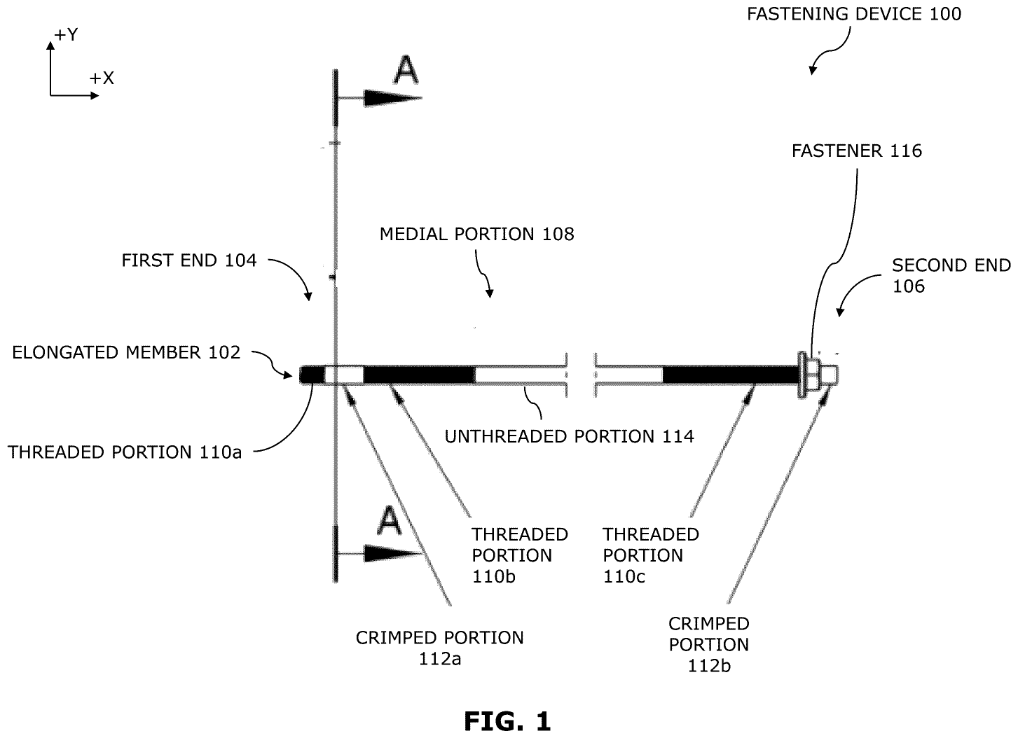

Referring now to FIG. 1, a fastening device 100 is provided. Fastening device 100 includes an elongated member 102 (e.g., a rod, a threaded rod, a partially threaded rod, a fully threaded rod, etc.). Elongated member 102 includes a first end 104 (e.g., a distal end), a second end 106 (e.g., a proximal end), and a medial portion 108. First end 104 includes a threaded portion 110a (e.g., a first threaded portion) and a crimped portion 112a. First end 104 includes at least a portion of threaded portion 110b. Medial portion 108 of elongated member 102 includes a plurality of features, including an unthreaded portion 114, at least a portion of threaded portion 110b, and at least a portion of a threaded portion 110c.

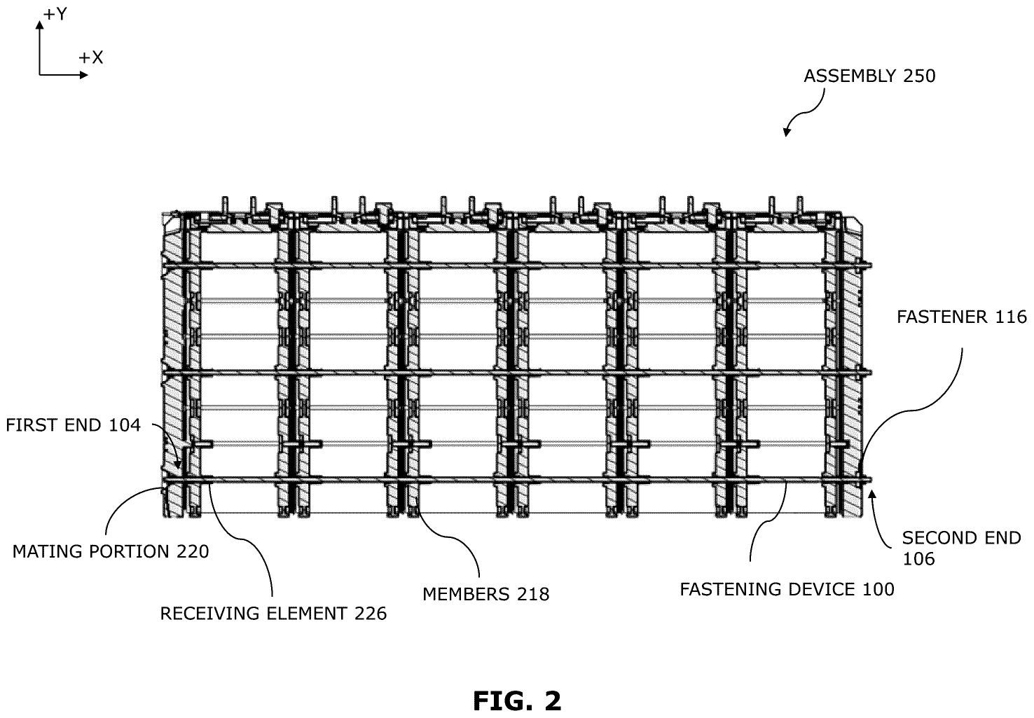

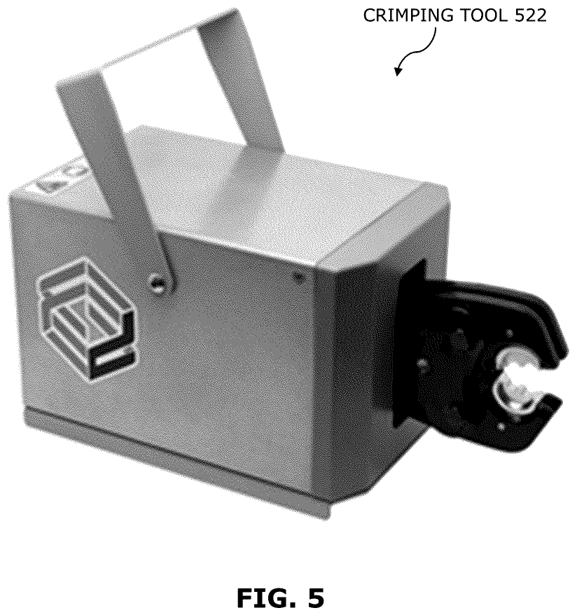

A crimping tool (e.g., crimping tool 522 of FIG. 5) may be used to crimp a portion of elongated member 102 to form crimped portion 112a. This crimping process deforms the existing threads and changes the geometry of elongated member 102. In some crimping operations, crimped portion 112a takes an “ovalized” or “oblong” shape, such that the ovalized or lengthened portion exceeds the initial (i.e., prior to crimping) outer diameter of the threads. In at least this aspect, a mating threaded element (e.g., see receiving element 226 of FIG. 2) is prevented from threading past crimped portion 112a.

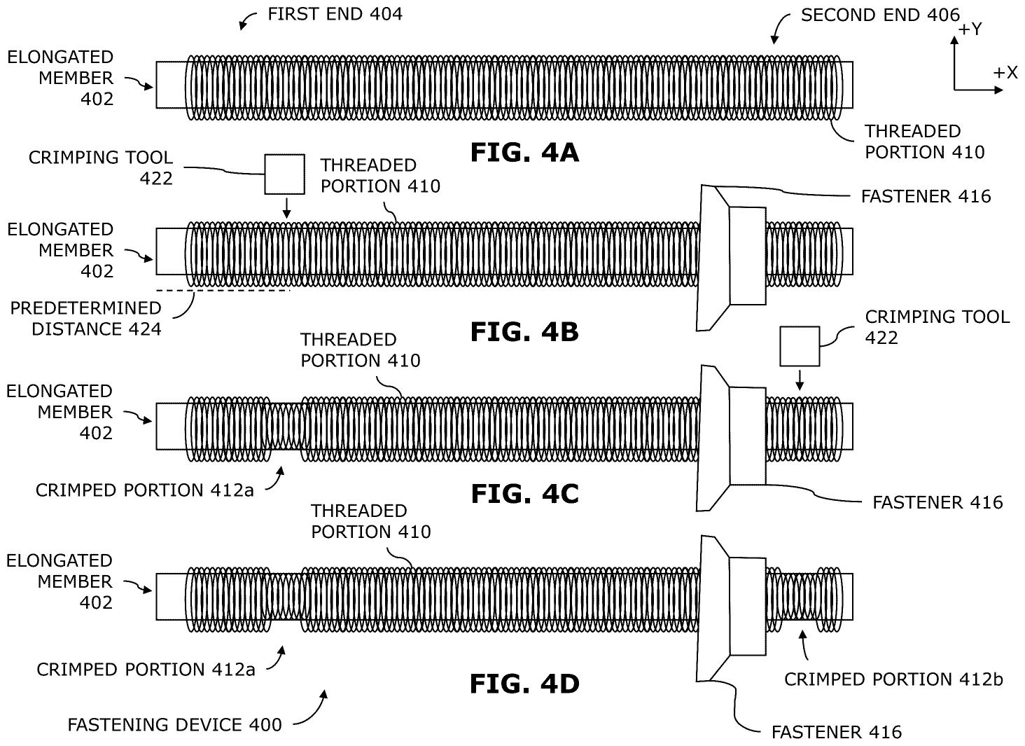

In some embodiments, prior to crimping, threaded portion 110a and threaded portion 110b may be considered to be a part of the same threaded portion, said threaded portion extending from medial portion 108 to first end 104 (i.e., a distal end). In another embodiment, threaded portion 110a and threaded portion 110b may have different thread characteristics (e.g., diameter, pitch, thread depth, rolled threads, cut threads, etc. depending on the application) and may be considered to be a part of different threaded portions. Although medial portion 108 illustrates unthreaded portion 114, the invention is not so limited (e.g., see threaded elongated member 402 of FIG. 4). In certain embodiments, the entire medial portion 108 may include threads along the length of medial portion 108.

Second end 106 of elongated member 102 is illustrated at a proximal end of elongated member 102 (i.e., the end where a user may be able to most easily access fastening device 100). Second end 106 includes at least a portion of threaded portion 110c.

Fastening device 100 includes a fastener 116 (e.g., a nut, a locknut, a wash nut, a nut and washer assembly, a jam nut, a plurality of nuts, a plurality of hardware, etc.). Fastener 116 is disposed on second end 106. Depending on the application, crimped portion 112b may be formed (e.g., using the crimping tool used to form crimped portion 112a, such as an FEK50 Pneumatic Crimping Press with a 2.5 ton output force, another crimping tool, another method of crimping, etc.) after fastener 116 is disposed (e.g., installed, placed, etc.) on second end 106.

In some embodiments of the invention, threaded portion 110a may engage with a mating portion (e.g., via a tapped hole, a threaded element, receiving element 226 of FIG. 2, etc.). In order to engage the mating portion (e.g., see mating portion 220 of FIG. 2), elongated member 102 may be passed through a plurality of different elements (e.g., see members 218 of FIG. 2) to be joined. For example, elongated member 102 may be passed through a plurality of holes (e.g., holes having a larger diameter than the portions of elongated member passing through said holes, including the crimped portions). Once threaded portion 110a engages with the mating portion, elongated member 102 may be rotated (e.g., manually, with a driving tool, a screwdriver, an inverted flat screwdriver, etc.) such that a desired amount of threaded portion 110a is engaged. In a subsequent step, fastener 116 may be tightened (e.g., with a socket wrench) to a desired value in furtherance of a fastening operation (e.g., to join a portion of a plurality of members to be assembled).

In certain embodiments, crimped portion 112a is formed at a predetermined location having a predetermined distance (e.g., from a terminal portion of first end 104). In such embodiments, threaded portion 110a engages with mating portion as a function of the predetermined location; in other words, after threading elongated member 102 such that the threads of the mating portion interfere with crimped portion 112a, rotation is impeded (i.e., the rod is prevented from spinning past crimped portion 112a). In some embodiments, first end 104 may include a thread locking material (e.g., a threadlocker, an adhesive, LOCTITE® threadlocker, etc.) to improve assembly (e.g., to prevent undesired rotation, loosening, etc.)

Referring now to FIG. 2, an assembly 250 is illustrated. Assembly 250 is useful for describing how fastening device 100 may be used. As illustrated, fastening device 100 (including the features as described in connection with FIG. 1) has been passed through a plurality of members 218 (e.g., lateral members of assembly 250) to engage with a receiving element 226 of a mating portion 220. It should be understood that the elements or portions of fastening device which have passed through a plurality of holes (i.e., of the plurality of members 218), including crimped portion 112a, should have a smaller diameter (or similar feature, such as the maximum length of an oblong shape, an oval, or another shape) than the smallest hole (i.e., of the plurality of members 218).

In the illustrated example, a user may have access to second end 106, but may not have practical access to first end 104. In such a situation where known devices may be used, it would be difficult, impractical, or impossible to determine the actual force through the rod or achieve the desired tightening without undesired rotation. Various inventive aspects of fastening device 100 make fastening, connecting, and assembling various elements of assembly 250 superior over known fastening techniques and devices in the art.

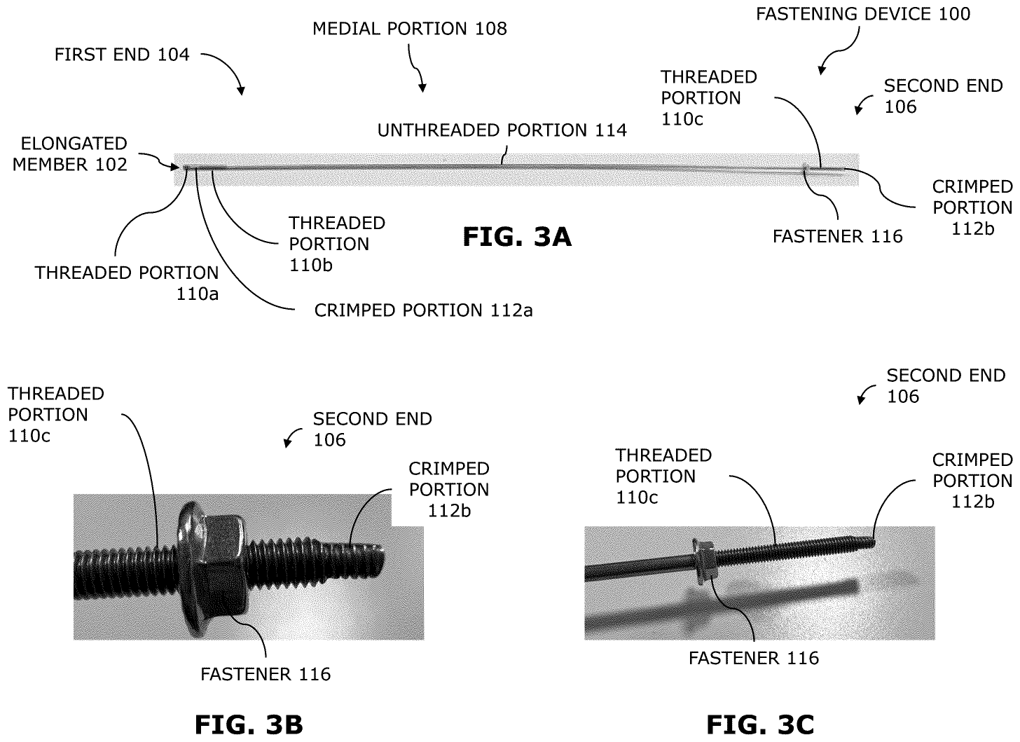

Referring now to FIGS. 3A-3C, various prototypes of fastening device 100 are illustrated. Referring specifically to FIG. 3A, a perspective view of a prototype of fastening device 100 is illustrated. Fastening device 100 uses the same reference numerals as FIG. 1, with the same (or substantially similar) features labelled accordingly. Referring now to FIG. 3B, a detailed view of second end 106 and fastener 116 is illustrated. Fastener 116 is illustrated near crimped portion 112b. Referring now to FIG. 3C, another detailed view of second end 106 and fastener 116 is illustrated. Fastener 116 is illustrated having been moved from crimped portion 112b toward first end 104 (i.e., the distal end, not illustrated).

Referring now to FIGS. 4A-4D, a method of providing (e.g., making, manufacturing, etc.) a fastening device 400 is illustrated. In FIG. 4A, elongated member 402 (e.g., a threaded rod) is provided. Elongated member 402 includes a threaded portion 410 along the length of elongated member 402 (i.e., along the X-axis). In FIG. 4B, a fastener 416 (e.g., a nut, a locknut, a wash nut, a nut and washer assembly, a jam nut, a plurality of nuts, etc.) is provided at a second end 406. A crimping tool 422 (e.g., crimping tool 522 of FIG. 5) is illustrated at a predetermined distance 424 of a first end 404 prior to a crimping step. In FIG. 4C, elongated member 402 has been crimped by crimping tool 422 to form crimped portion 412a. Crimping tool 422 has been moved to a distal position from first end 404. In FIG. 4D, a crimped portion 412b (i.e., a second crimped portion) has been formed from crimping tool 422 (or another crimping tool). Crimped portion 412b is located at a distal position from first end 404. Crimped portion 412b is located such that fastener 416 is prevented from detaching from elongated member 402 (e.g., by impeding an unthreading action of fastener 416 beyond the limit of second end 406 in the +X direction).

Referring now to FIG. 5, an exemplary crimping tool 522 is illustrated. Crimping tool 522 may be the FEK50 Pneumatic Crimping Press with a 2.5 ton output force. Of course, it is understood by one of ordinary skill in the art that a plurality of different crimping tools (with different specifications) may be used in accordance with exemplary embodiments of the disclosure and fall within its scope.

FIGS. 6A and 6B illustrate what has been referred to herein as a slotted bit or driving tool, which is essentially a means to engage the crimped end to turn it to drive it into threads. In the slotted bit shown in FIG. 6, it essentially resembles a slotted head screw, i.e., it is an inverted version of a slotted head screw bit.

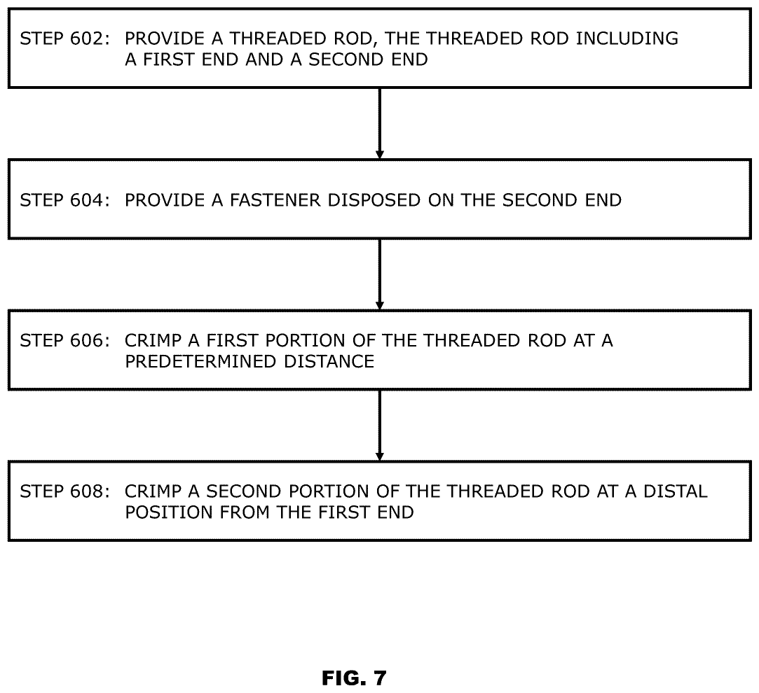

FIG. 7 is a flow diagram illustrating method providing a fastening device, in accordance with various exemplary embodiments of the invention. As is understood by those skilled in the art, certain steps included in the flow diagrams may be omitted; certain additional steps may be added; and the order of the steps may be altered from the order illustrated. In Step 602, a threaded rod is provided (e.g., see FIG. 4A), the threaded rod including a first end and a second end. In Step 604, a fastener, disposed on the second end, is provided (e.g., see FIG. 4B). In Step 606, a first portion of the threaded rod is crimped at a predetermined distance (e.g., see FIGS. 4B-4C). In Step 608, a second portion of the threaded rod is crimped at a distal position from the first end (e.g., see FIGS. 4C-4D).

### EQUIVALENTS

Although preferred embodiments of the invention have been described using specific terms, such description is for illustrative purposes only, and it is to be understood that changes and variations may be made without departing from the spirit or scope of the following claims.

1. A fastening device comprising:
an elongated member, the elongated member including
a first end including a first threaded portion and a first crimped portion, and
a second end including a second threaded portion; and
a fastener, the fastener disposed on the second end.

2. The fastening device of claim 1 wherein the first crimped portion is configured to prevent the elongated member from rotating.

3. The fastening device of claim 2 wherein the first crimped portion is located at a predetermined distance from the first end.

4. The fastening device of claim 1 wherein the second end includes a second crimped portion.

5. The fastening device of claim 4 wherein the second crimped portion is located at a distal position from the first end, the second crimped portion being located such that the fastener is prevented from detaching from the elongated member.

6. The fastening device of claim 1 wherein the fastener is a nut.

7. The fastening device of claim 1 wherein the fastener is configured to secure the elongated member.

8. The fastening device of claim 1 wherein the fastener is configured to interact with a socket to tighten the fastener to a torque value.

9. The fastening device of claim 1 wherein the elongated member is a rod.

10. The fastening device of claim 1 wherein the elongated member is a threaded rod.

11. The fastening device of claim 1 wherein the first end is configured to interact with a thread locking material.

12. The fastening device of claim 1 wherein the elongated member is configured to be tightened into a threaded element by a driving tool.

13. The fastening device of claim 1 wherein the driving tool comprises a slotted bit.

14. A method of providing a fastening device, the method comprising the steps of:
(a) providing a threaded rod, the threaded rod including a first end and a second end;
(b) providing a fastener disposed on the second end;
(c) crimping a first portion of the threaded rod at a predetermined distance; and
(d) crimping a second portion of the threaded rod at a distal position from the first end.
